(19) United States
(12) Patent Application Publication
(10) Pub. No.: US 2010/0274492 A1
(43) Pub. Date: Oct. 28, 2010

(54) DETERMINING ATTRIBUTES OF SEISMIC EVENTS

(76) Inventors: Susanne Rentsch, Brighton (GB); Dirk-Jan Van Manen, Reigate (GB)

Correspondence Address: Jeffrey E. Griffin, IP Dept.;WesternGeco L. L. C., 10001 Richmond Avenue, Houston, TX, 77042, US

(21) Appl. No.: 12/429,288

(22) Filed: Apr. 24, 2009

(51) Int. Cl. G01V 1/28

(52) U.S. Cl. 702/14

(57) ABSTRACT

A technique includes receiving seismic data, which are acquired by a seismic sensor. The seismic data are indicative of an observed wavefield quantity that is associated with a seismic event. The technique includes determining a candidate event for an observed wavefield quantity based at least in part on a ghost model, a source wavelet and a candidate value for at least one directional attribute quantity of the seismic event; correlating the candidate event with the observed wavefield quantity; and determining an event time based on the correlating.

### BACKGROUND

The invention generally relates to determining attributes of seismic events.

Seismic exploration involves surveying subterranean geological formations for hydrocarbon deposits. A survey typically involves deploying seismic source(s) and seismic sensors at predetermined locations. The sources generate seismic waves, which propagate into the geological formations creating pressure changes and vibrations along their way. Changes in elastic properties of the geological formation scatter the seismic waves, changing their direction of propagation and other properties. Part of the energy emitted by the sources reaches the seismic sensors. Some seismic sensors are sensitive to pressure changes (hydrophones), others to particle motion (e.g., geophones), and industrial surveys may deploy only one type of sensors or both. In response to the detected seismic events, the sensors generate electrical signals to produce seismic data. Analysis of the seismic data can then indicate the presence or absence of probable locations of hydrocarbon deposits.

Some surveys are known as “marine” surveys because they are conducted in marine environments. However, “marine” surveys may be conducted not only in saltwater environments, but also in fresh and brackish waters. In one type of marine survey, called a “towed-array” survey, an array of seismic sensor-containing streamers and sources is towed behind a survey vessel.

### SUMMARY

In an embodiment of the invention, a technique includes receiving seismic data, which are acquired by a seismic sensor. The seismic data are indicative of an observed wavefield quantity that is associated with a seismic event. The technique includes determining a candidate event for an observed wavefield quantity based at least in part on a ghost model, a source wavelet and a candidate value for at least one directional attribute quantity of the seismic event; correlating the candidate event with the observed wavefield quantity; and determining an event time based on the correlating.

In yet another embodiment of the invention, a system includes an interface and a processor. The interface receives seismic data that is acquired by a seismic sensor and are indicative of the observed wavefield quantity that is associated with a seismic event. The processor is adapted to process the seismic data to create a candidate event for the observed wavefield quantity based at least in part on a ghost model, a source wavelet and a candidate value for a directional attribute quantity of the seismic event. The processor is further adapted to correlate the candidate event with the observed wavefield quantity and determine a candidate event time based on the correlation.

Advantages and other features of the invention will become apparent from the following drawing, description and claims.

### BRIEF DESCRIPTION OF THE DRAWING

FIG. 1 is a schematic diagram of a marine-based seismic acquisition system according to an embodiment of the invention.

FIG. 2 is an illustration of directional propagation attributes of a plane wave according to an embodiment of the invention.

FIG. 3 is an illustration of time delays at a seismic sensor between an arriving plane wave and its ghost versus the incidence angle of the plane wave for different sensor depth levels.

FIG. 4 is a graph illustrating a synthetic total pressure wavefield versus incidence angle according to an embodiment of the invention.

FIG. 5 is an illustration of a synthetic vertical particle velocity wavefield versus incidence angle according to an embodiment of the invention.

FIGS. 6, 7A and 7B are flow diagrams depicting techniques to determine attributes of seismic events according to embodiments of the invention.

FIG. 8 is a schematic diagram of a data processing system according to an embodiment of the invention.

### DETAILED DESCRIPTION

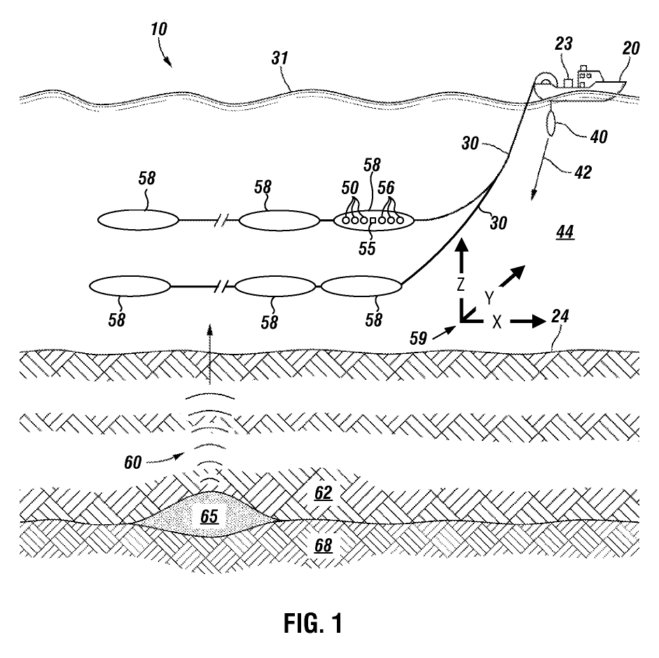

FIG. 1 depicts an embodiment 10 of a marine seismic data acquisition system in accordance with some embodiments of the invention. In the system 10, a survey vessel 20 tows one or more seismic streamers 30 behind the vessel 20. It is noted that the streamers 30 may be arranged in a number of different geometries, depending on the particular embodiment of the invention. For the streamer spread that is depicted in FIG. 1, the spread is an over/under spread that includes an array of one or more streamers that is towed above another array of one or more streamers 30. However, the streamers 30 may be arranged in various other geometries (such as a geometry in which the streamers 30 are generally towed in the same horizontal plane, for example), depending on the particular embodiment of the invention.

The seismic streamers 30 may be several thousand meters long and may contain various support cables (not shown), as well as wiring and/or circuitry (not shown) that may be used to support communication along the streamers 30. In general, each streamer 30 includes a primary cable into which are mounted seismic sensors that record seismic signals.

In accordance with embodiments of the invention, the streamer 30 contains seismic sensor units 58. In some embodiments of the invention, the seismic sensor units 58 may include sensors to detect a pressure. In other embodiments of the invention, each seismic sensor unit 58 forms a multi-component seismic sensor station, in that each seismic sensor unit 58 contains sensors to detect a pressure wavefield and at least one component of a particle motion. Examples of particle motions include one or more components of a particle displacement, one or more components (inline (x), crossline (y) and vertical (z) components (see axes 59, for example)) of a particle velocity and one or more components of a particle acceleration.

Depending on the particular embodiment of the invention, the seismic sensor unit 58 may include one or more hydrophones, geophones, particle displacement sensors, particle velocity sensors, accelerometers, pressure gradient sensors, or combinations thereof.

For example, in accordance with some embodiments of the invention, a seismic sensor unit 58 may include a hydrophone 55 for measuring pressure and three orthogonally-aligned accelerometers 50 to measure three corresponding orthogonal components of particle velocity and/or acceleration near the seismic sensor unit 58. It is noted that the sensors of the seismic sensor unit 58 may be implemented as a single device (as depicted in FIG. 1) or may be implemented as a plurality of devices, depending on the particular embodiment of the invention. A particular seismic sensor unit 58 may also include pressure gradient sensors 56, which constitute another type of particle motion sensor. Each pressure gradient sensor measures the change in the pressure wavefield at a particular point with respect to a particular direction. For example, one of the pressure gradient sensors 56 may acquire seismic data indicative of, at a particular point, the partial derivative of the pressure wavefield with respect to the crossline direction, and another one of the pressure gradient sensors 56 may acquire, at a particular point, seismic data indicative of the partial derivative of the pressure data with respect to the inline direction. The pressure gradient sensors 56 may also acquire, as an example, a vertical pressure gradient.

The marine seismic data acquisition system 10 includes one or more seismic sources 40 (one exemplary source 40 being depicted in FIG. 1), such as air guns and the like. In some embodiments of the invention, the seismic source(s) 40 may be coupled to, or towed by, the survey vessel 20. Alternatively, in other embodiments of the invention, the seismic sources 40 may operate independently of the survey vessel 20, in that the seismic source(s) 40 may be coupled to other vessels or buoys, as just a few examples.

Alternatively, in other embodiments of the invention no seismic source is operated, and an acoustic signal emitted outside the acquisition system is used. More specifically, the systems and techniques that are described herein may be applied to passive seismic applications, such as (as a non-limiting example) an application in which seismic sensors are used to record earthquake-derived seismic activity.

As the seismic streamers 30 are towed behind the survey vessel 20, acoustic signals 42 (an exemplary acoustic signal 42 being depicted in FIG. 1), often referred to as “shots,” are produced by the seismic source(s) 40 and are directed down through a water column 44 into strata 62 and 68 beneath a water bottom surface 24. The acoustic signals 42 are reflected from the various subterranean geological formations, such as an exemplary formation 65 that is depicted in FIG. 1.

The incident acoustic signals 42 that are emitted by the sources 40 produce corresponding reflected acoustic signals, or pressure waves 60, which are sensed by the sensors of seismic sensor units 58. It is noted that the pressure waves that are received and sensed by the seismic sensors include “up going” pressure waves that propagate to the sensors as reflections from the subsurface, as well as “down going” pressure waves that are produced by reflections of the pressure waves 60 from an air-water boundary 31.

The seismic sensors generate signals (digital signals, for example), called “traces,” which indicate the acquired measurements of the pressure wavefield and/or particle motion, depending on the particular embodiment of the invention. The traces are recorded and may be at least partially processed by a signal processing unit 23 that is deployed on the survey vessel 20, in accordance with some embodiments of the invention. For example, a particular seismic sensor unit 58 may provide a trace, which corresponds to a measure of a pressure wavefield by its hydrophone 55; and the seismic sensor unit 58 may provide one or more traces that correspond to one or more components of particle motion, which are measured by its accelerometers 50.

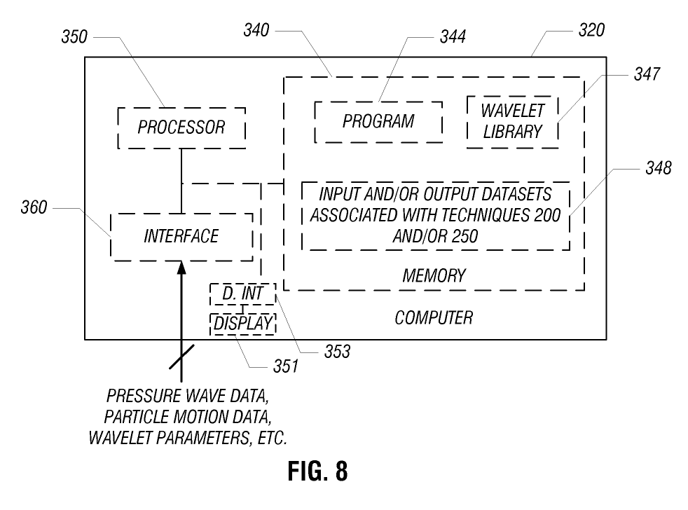

The goal of the seismic acquisition is to build up an image of a survey area for purposes of identifying subterranean geological formations, such as the exemplary geological formation 65. Subsequent analysis of the representation may reveal probable locations of hydrocarbon deposits in subterranean geological formations. Depending on the particular embodiment of the invention, portions of the analysis of the representation may be performed on the seismic survey vessel 20, such as by the signal processing unit 23. In accordance with other embodiments of the invention, the representation may be processed by a seismic data processing system (such as an exemplary seismic data processing system 320 that is depicted in FIG. 8 and is further described below) that may be, for example, located on land or on the vessel 20. Thus, many variations are possible and are within the scope of the appended claims.

The down going pressure waves create an interference known as “ghost” in the art. Depending on the incidence angle of the up going wavefield and the depth of the streamer 30 and the velocity of sound in water, the interference between the up going and down going wavefields creates nulls, or notches, in the recorded spectrum. These notches may reduce the useful bandwidth of the spectrum and may limit the possibility of towing the streamers 30 relatively deep (tow depth greater than 10 meters (m), for example).

The techniques of decomposing the recorded wavefield into up and down going components are often referred to as wavefield separation, or “deghosting.” The vertical particle motion data and vertical pressure gradient data that are provided by particle motion sensors allows the recovery of “ghost” free data, which means data that is indicative of the upgoing wavefield.

A seismic event has certain attributes, such as its directional propagation attributes (such as an azimuth and an angle of incidence, for example), its amplitude and a time of arrival. Techniques and systems are described herein for purposes of determining the attributes of one or more seismic events that are observed via measurements of event(s), which are acquired by seismic sensors.

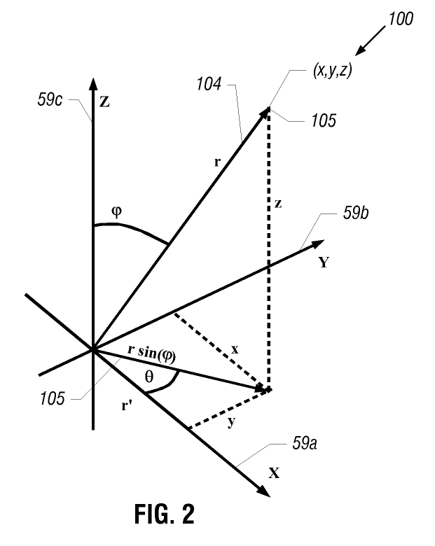

Using a compressional wave representation for the seismic event, the seismic event may be viewed as propagating in parallel to a three-dimensional (3-D) vector 104 (see FIG. 2). The orientation of the vector (104) (and thus, the orientation of the seismic event) may be described by a 3-D incidence angle called “φ” (varying from 0 to 180 degrees) and an azimuth called “θ” (varying from 0 to 360 degrees). FIG. 2 depicts the vector 104 with respect to the following orthogonal axes: a depth, or z, axis 59c; an inline, or x, axis 59a that is directed along the streamer length; and a crossline, or y, axis 59b. The incidence angle φ is the angle between the plane wave vector 104 and the z axis 59c, and the azimuth θ is the angle between the x axis 59a and a projection 105 of the vector 104 onto the x-y plane.

The azimuth θ may be described as follows:

$$θ = \{ \begin{matrix}{tan}^{- 1} ( \frac{y}{x} ) & if x > 0 and y \geq 0 \\ {tan}^{- 1} ( \frac{y}{x} ) + 360 & if x > 0 and y < 0 \\ {tan}^{- 1} ( \frac{y}{x} ) + 180 & if x < 0 \\ 90 & if x = 0 and y > 0 \\ 270 & if x = 0 and y < 0 ,\end{matrix} \qquad Eq . 1$$

with x and y being the horizontal components of the vector 104. Furthermore, the incidence angle φ may be described as follows:

$$ϕ = {cos}^{- 1} ( \frac{z}{r} ) , \qquad Eq . 2$$

with “z” being the vertical component of the vector “r” 104. The projection “q” 105 of the measured vector 104 onto the x-y plane may be described as follows:

Proj_{x,y}=q=\sqrt{x²+y²}=r·sin(φ), Eq. 3

The x, y and z components of the seismic event may be described as follows:

x=r cos(θ)·sin(φ), Eq. 4

y=r sin(θ)·sin(φ), and Eq. 5

z=r cos(θ). Eq. 6

As described below, the above-described propagation attributes of a seismic event are determined by modeling the associated pressure and particle motion wavefields as functions of a known or estimated source wavelet (called “u(t)” herein) and determining the parameters of wavelet functions determined from the u(t) source wavelet that cause the functions to best fit the observed seismic measurements. The approximate share of the u(t) source wavelet may be determined (as non-limiting examples) from near field measurements or from an estimation made based on the observed direct wave. A particular upgoing pressure wavefield may be described by the u(t) source wavelet as follows:

wp^{up}(t)=u(t), Eq. 7

where “wp^{up} (t)” represents the upgoing pressure wavefield. Using the relationships that are set forth in Eqs. 4-6, the corresponding particle motion wavefields may be represented in terms of the u(t) source wavelet as follows:

$$\begin{matrix}{wx}^{up} ( t ) = \frac{u ( t )}{ρ \cdot c} \cdot cos ( θ ) \cdot sin ( ϕ ) , & Eq . 8 \\ {wy}^{up} ( t ) = \frac{u ( t )}{ρ \cdot c} \cdot sin ( θ ) \cdot sin ( ϕ ) , \\ and & Eq . 9 \\ {wz}^{up} ( t ) = \frac{u ( t )}{ρ \cdot c} \cdot cos ( ϕ ) , & Eq . 10\end{matrix}$$

where “wx^{up} (t)” represents the inline upgoing particle velocity wavefield; “wy^{up} (t)” represents the crossline upgoing particle velocity wavefield; “wz^{up} (t)” represents the vertical upgoing particle velocity wavefield; “ρ” represents the density of water; and “c” represents the sound velocity in water. Thus, the product ρ·c represents a scaling factor between the pressure and particle velocities. Eqs. 7-10 therefore describe synthetic, or modeled pressure and particle velocity wavefields in terms of the u(t) source wavelet. It is noted that the angle of incidence φ for an upgoing wavefield only has a range between 0 to 90 degrees, which corresponds to the upper half hemisphere of a sphere.

For purposes of illustrating one out of many possible embodiments of the invention, a flat sea surface ghost model is assumed, and it is also assumed that the upgoing wavefields may be approximated as plane waves. Given this ghost model representation, the downgoing wavefields may be represented, respecting, for instance, an ideal flat sea surface reflection coefficient R=−1, in terms of the u(t) source wavelet, as follows:

$$\begin{matrix}{wp}^{down} ( t + Δ {t}_{ghost} ) = R \cdot u ( t ) , & Eq . 11 \\ {wx}^{down} ( t + Δ {t}_{ghost} ) = \frac{R \cdot u ( t )}{ρ \cdot c} \cdot cos ( θ ) \cdot sin ( ϕ ) , & Eq . 12 \\ {wy}^{down} ( t + Δ {t}_{ghost} ) = \frac{R \cdot u ( t )}{ρ \cdot c} \cdot sin ( θ ) \cdot sin ( ϕ ) , \\ and & Eq . 13 \\ {wz}^{down} ( t + Δ {t}_{ghost} ) = \frac{- R \cdot u ( t )}{ρ \cdot c} \cdot cos ( ϕ ) , & Eq . 14\end{matrix}$$

where “wp^{down} (t+Δt_{ghost})” represents the downgoing pressure wavefield; “wx^{down} (t+Δt_{ghost})” represents the downgoing inline vertical particle velocity wavefield; “wy^{down} (t+Δt_{ghost})” represents the downgoing crossline particle velocity wavefield; and “wz^{down} (t+Δt_{ghost})” represents the downgoing vertical particle velocity wavefield. The time delay Δt_{ghost} between the upgoing wavefield and its free sea surface reflection depends on the streamer depth (called “r_{z},”), the angle of incidence φ and the sound velocity in water c, as described below:

$$Δ {t}_{ghost} = \frac{2 \cdot cos ( ϕ ) \cdot {r}_{z}}{c} . \qquad Eq . 15$$

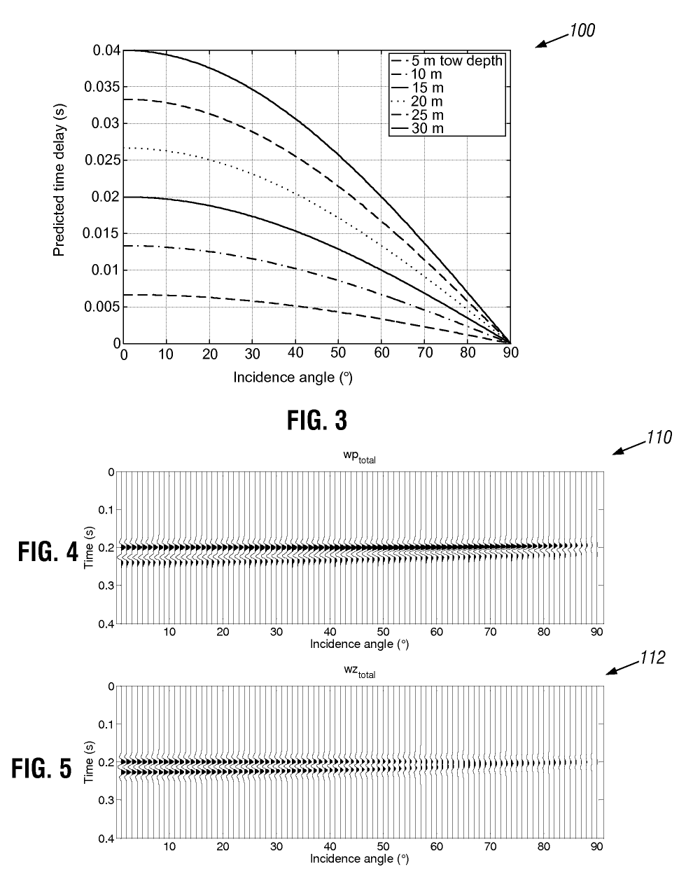

The streamer depth r_{z}, water velocity c (and density ρ) are measurable, or assessable, variables that do not vary significantly over a shot record time. In contrast, the angle of incidence φ may vary significantly over a shot record, due to the different angles of the arriving seismic events. For example, the later arriving events from deeper reflectors typically have smaller incidence angles φ, as compared to the early arriving events. There are exceptions, however, where higher incidence angles are observed in later arriving events (e.g., diffractions or side reflections, for example). The relationship between the parameters in Eq. 15 is shown in FIG. 3, which is a graph 100 depicting a time delay between an arriving plane wave and its ghost versus the incidence angle of the incoming plane wave for six different sensor depths.

Assuming the time delay Δt_{ghost} is known, the total synthetic wavefield w^{l}ₛ(t) for each wavefield quantity or component l (where l=(p, x, y, z)) may be described as follows:

wₛ^{x}=wp^{up}(t)+wp^{down}(t+Δt_{ghost}), Eq. 16

wₛ^{x}=wx^{up}(t)+wx^{down}(t+Δt_{ghost}), Eq. 17

wₛ^{y}=wy^{up}(t)+wy^{down}(t+Δt_{ghost}), and Eq. 18

wₛ^{Z}=wz^{up}(t)+wz^{down}(t+Δt_{ghost}). Eq. 19

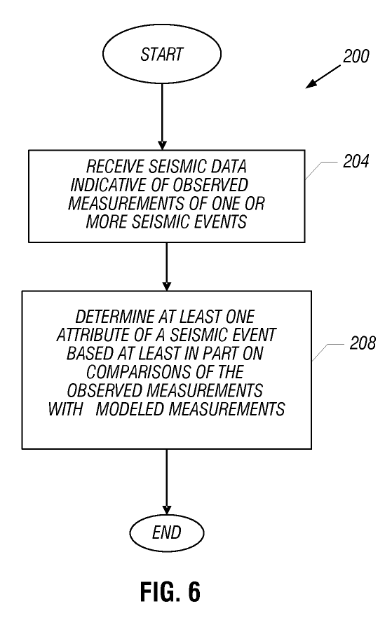

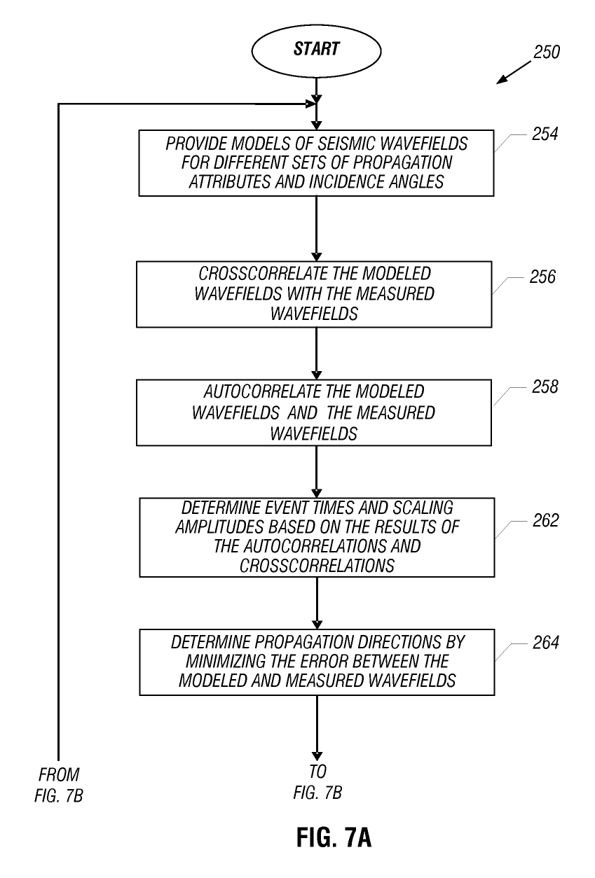

Because the ghost operator depends on the angle of incidence φ (see Eq. 15), the angle of incidence φ changes the shape of the synthetic wavefield. This change is illustrated in FIG. 4, which depicts the synthetic total pressure wavefield 110 versus the incidence angle φ and in FIG. 5, which depicts the synthetic vertical particle velocity 112 versus incidence angle φ. As such, the shape of the wavelet changes due to the change of the ghost interference. It is noted that the shape of the horizontal particle motion changes as a function of incidence angle and azimuth. Due to the many possible combinations for purposes of clarity, this relationship is not depicted in FIG. 5.

The equations set forth above for the synthetic wavelet-based wavefields may be expanded to predict the wavefields at adjacent seismic sensors, or receivers. For example, given the plane wave representation, the arrival time difference (called “Δtₙ”) between a sensor located at position (xₗ, yₗ, zₗ) and another sensor n located at position (xₙ, yₙ, zₙ) is a linear function for each individual propagation direction. For a sensor n, the synthetic wavefields wₛ^{l}(tₙ) relative to the reference sensor may be described as follows:

wₛ^{p}(tₙ)=wp^{up}(t+Δtₙ)+wp^{down}(t+Δtₙ+Δt_{ghost}), Eq. 20

wₛ^{x}(tₙ)=wx^{up}(t+Δtₙ)+wx^{down}(t+Δtₙ+Δt_{ghost}), Eq. 21

wₛ^{y}(tₙ)=wy^{up}(t+Δtₙ)+wy^{down}(t+Δtₙ+Δt_{ghost}), and Eq. 22

wₛ^{z}(tₙ)=wz^{up}(t+Δtₙ)+wz^{down}(t+Δtₙ+Δt_{ghost}). Eq. 23

It is noted that in accordance with other embodiments of the invention, the arrival time differences may be predictable using different representations than the plane wave representation. Furthermore, it is noted that the arrival time difference Δtₙ between sensors is a function of incidence angle φ and azimuth θ.

As described herein, synthetic wavefields are generated for different sets of incidence angles φ and azimuths θ to generate modeled measurements of a seismic event. In some embodiments of the invention, these modeled measurements are stored in a library. However, in other embodiments of the invention, the synthetic wavelets are not predetermined and stored in a library. Instead, the synthetic wavelets may be determined dynamically on the fly.

The observed measurements of the seismic event, which are derived from the acquired seismic data, are compared to the modeled measurements and, as described herein, these comparisons are used to solve for attributes of the event, such as the event time, the event amplitude, the angle of incidence φ and the azimuth θ. It is noted that the acquired seismic data may indicate observed measurements for several seismic events, a scenario which is accounted for as described below. An iterative procedure identifies the synthetic wavelets in the library, which best describe the observed measurements of the seismic event.

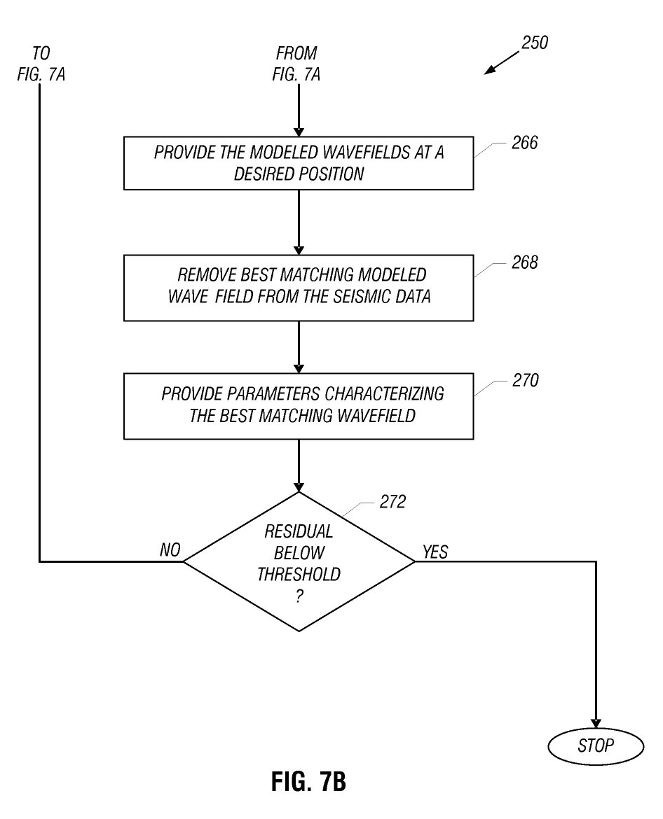

Thus, to summarize, a technique 200, which is depicted in FIG. 6, may be used in accordance with some embodiments of the invention. Pursuant to the technique 200, seismic data, which are indicative of one or more observed seismic events are received, pursuant to block 204. The technique 200 includes determining (block 208) attributes of a seismic event by comparing the observed measurements (indicated by the seismic data) to modeled measurements for different sets of propagation parameters.

Thus, in some embodiments of the invention, the first step of the inversion involves the creation of a library of synthetic wavefields by calculating the wavefields described in Eqs. 20-23 over a range of incidence angles φ (incidence angles φ from 0 to 90 degrees) and azimuths θ (azimuths from 0 to 360 degrees). With a priori information available the range of incidence angles and azimuths may be restricted. The arrival or event, time (called “tᵢ” herein), the wavelet amplitude scaling factor (called “mᵢ” herein) as well as the angle of incidence φ and the azimuth θ of event i may be obtained simultaneously in the spatio-temporal domain by minimizing a residual error Δᵢ, as described below:

$${Δ}_{i} ( {t}_{i} , {m}_{i} , {ϕ}_{i} , {θ}_{i} ) = {\sum }_{n = 1}^{N} {\sum }_{l = 1}^{4} {\int }_{0}^{∞} {[ \begin{matrix}{w}_{o}^{l} ( {t}_{n} ) - \\ {m}_{i} {w}_{s}^{l} ( {t}_{n} - {t}_{i} , {ϕ}_{i} , {θ}_{i} )\end{matrix} ]}^{2} d t , \qquad Eq . 24$$

where “n” represents the receiver index and ranges from 1 to N, and “l” represents the index to the particular wavefield quantity (i.e., the index to the pressure or one of the three particle motion wavefields). Eq. 24 may be restated in terms of correlation functions as follows:

$${Δ}_{i} ( {t}_{i} , {m}_{i} , {ϕ}_{i} , {θ}_{i} ) = {\sum }_{n = 1}^{N} {\sum }_{l = 1}^{4} ( \begin{matrix}{r}_{o ( n )}^{l} ( 0 ) - \\ 2 \cdot {m}_{i} {r}_{os ( n )}^{l} ( {t}_{i} ) + {r}_{s ( n )}^{l} ( 0 ) {m}_{i}^{2}\end{matrix} ) , \qquad Eq . 25$$

where “rₒₛ₍ₙ₎” represents the crosscorrelation between the observed and modeled wavefields at seismic sensor unit n, and “rₒ₍ₙ₎(0)” and “rₛ₍ₙ₎(0)” are the autocorrelations of the measured and synthetic wavefields, respectively, at zero time lag.

With respect to the scaling factor mᵢ, Eq. 25 is quadratic. Furthermore, the autocorrelations at zero time lag are positive. Therefore, Eq. 25 may be rewritten by taking the derivative of the residual error Δᵢ(tᵢ,mᵢ,φᵢ,θᵢ) with respect to the amplitude, or scaling factor, (called “mᵢ,”) and setting the derivative to zero as described below:

$$\frac{\partial {Δ}_{i} ( {t}_{i} , {m}_{i} , {ϕ}_{i} , {θ}_{i} )}{\partial {m}_{i}} = 0 , \qquad Eq . 26$$

Solving Eq. 26 mᵢ yields the following:

$$\frac{{\sum }_{n = 1}^{N} {\sum }_{l = 1}^{4} {r}_{os ( n )}^{l} ( {t}_{i} )}{{\sum }_{n = 1}^{N} {\sum }_{l = 1}^{4} {r}_{s ( n )}^{l} ( 0 )} = {m}_{i} . \qquad Eq . 27$$

Note, that the event amplitude mᵢ cannot be determined from Eq. 27 until the event time tᵢ is known. By substituting Eq. 27 into Eq. 25, the following relationship may be obtained:

$${Δ}_{i} ( {t}_{i} , {m}_{i} , {ϕ}_{i} , {θ}_{i} ) = {\sum }_{n = 1}^{N} {\sum }_{l = 1}^{4} {r}_{o ( n )}^{l} ( 0 ) - \frac{{( {\sum }_{n = 1}^{N} {\sum }_{l = 1}^{4} {r}_{os ( n )}^{l} ( {t}_{i} ) )}^{2}}{{\sum }_{n = 1}^{N} {\sum }_{l = 1}^{4} {r}_{s ( n )}^{l} ( 0 )} , \qquad Eq . 28$$

With the autocorrelations at zero time lag and the square of the crosscorrelations being positive, the event time tᵢ is determined as follows:

$${( {\sum }_{n = 1}^{N} {\sum }_{l = 1}^{4} {r}_{os ( n )}^{l} ( {t}_{i} ) )}^{2} = max . \qquad Eq . 29$$

The event time tᵢ is then substituted into Eq. 27 to determine the event amplitude mᵢ.

For each incidence angle φ and azimuth θ, synthetic wavefields are obtained. Each synthetic wavefield has a corresponding event time tᵢ and scaling factor mᵢ. These synthetic wavefields may be used to calculate the corresponding residuals between the observed wavefields and the synthetic wavefields, as set forth below:

$${res}_{i} ( {ϕ}_{i} , {θ}_{i} ) \vert {t}_{i} , {m}_{i} = {\sum }_{n = 1}^{N} {\sum }_{l = 1}^{4} {r}_{o ( n )}^{l} ( 0 ) - {m}_{i}^{2} {\sum }_{n = 1}^{N} {\sum }_{l = 1}^{4} {r}_{s ( n )}^{l} ( 0 ) , \qquad Eq . 30$$

wherein “resᵢ(φᵢ, θᵢ)|tᵢ, mᵢ” represents the set of residuals for the given arrival time tᵢ and scaling factor mᵢ for the different angles of incidence φ and azimuths θ.

The minimum of the residual function resᵢ(φᵢ, θᵢ)|tᵢ, mᵢ corresponds to the incidence angle φ and the azimuth θ of the most energetic event i, which occurs at the event time tᵢ and has an amplitude mᵢ.

Depending on the particular embodiment of the invention, a residual may be obtained using Eq. 30 or in other ways. For instance, in another embodiment Eq. 24, or Eq. 25, or Eq. 28 may be used.

Using the determined event time tᵢ, scaling factor mᵢ, incidence angle φᵢ and azimuth θᵢ, the upgoing synthetic wavefields may be determined at a particular desired position. Furthermore, the remaining wavefield for all measured components at any receiver n may be determined as follows:

ŵₒ₍ₙ₎^{p}(t)=wₒ₍ₙ₎^{p}(tᵢ)−mᵢwₛ₍ₙ₎^{p}(t−tᵢ,φᵢ), Eq. 31

ŵₒ₍ₙ₎^{x}(t)=wₒ₍ₙ₎^{x}(tᵢ)−mᵢwₛ₍ₙ₎^{x}(t−tᵢ,φᵢ,θᵢ), Eq. 32

ŵₒ₍ₙ₎^{y}(t)=wₒ₍ₙ₎^{y}(tᵢ)−mᵢwₛ₍ₙ₎^{y}(t−tᵢ,φᵢ,θᵢ),and Eq. 33

ŵₒ₍ₙ₎^{z}(t)=wₒ₍ₙ₎^{z}(tᵢ)−mᵢwₛ₍ₙ₎^{l}(t−tᵢ,φᵢ), Eq. 34

where “ŵₒ₍ₙ₎^{p}(t)”, “ŵₒ₍ₙ₎^{x}(t)”, “ŵₒ₍ₙ₎^{y}(t)”, and “ŵₒ₍ₙ₎^{z}(t)” represent the remaining synthetic wavefields for the total pressure, inline particle velocity, crossline particle velocity and vertical particle velocity, respectively.

Using the remaining wavefields that are set forth in Eqs. 31-34, the parameters for a second event i=2 may be estimated substituting the initial input data with these remaining wavefields. The above-described procedure may be iterated for other seismic events until no more significant change in the calculated residuals is observed or the energy of the input data reaches a threshold. This threshold may be user defined or linked to the ambient noise.

Thus, referring to FIGS. 7A and 7B, a technique 250 may be performed in accordance with embodiments of the invention. Pursuant to the technique 250, all possible or desired combinations of the pressure and particle motion wavefields are modeled (block 254) for different sets of propagation directions and incidence angle dependent ghost operators (when applicable). Thus, an initial determination may be made regarding the potential ranges over which the seismic event attributes may vary. The modeled wavefields are crosscorrelated (block 256) with the observed wavefields, and the modeled wavefields and the measured wavefields are autocorrelated, pursuant to block 258.

The technique 250 includes determining event time and scaling factors based on the autocorrelation and crosscorrelation results, pursuant to block 262. Given these parameters, propagation attributes of the seismic event may be determined (block 264) by minimizing the error between the modeled and measured wavefields.

It is noted that an exhaustive search over the propagation directions is one particular embodiment but other optimization/minimization techniques might be used, such as searching over the range of possible propagation directions systematically or randomly, or using a priori information to restrict the search, in accordance with other embodiments of the invention.

Next, according to the technique 250, the modeled wavefields are output (block 266), and the best matching modeled wavefield is removed from the measured data in order to prepare for the determination of the attributes of the next seismic event, pursuant to block 268. Furthermore, in accordance with some embodiments of the invention, parameters may be furnished, pursuant to block 270, which characterize the best matching wavefield. If a determination is made, pursuant to diamond 272, that the residual of the minimization function is larger than a defined threshold or the change in the calculated residuals between iterations is larger than a defined threshold, then control returns to block 254 for the next iteration. Otherwise, the technique 250 terminates, as the attributes for all significant events have been determined.

Advantages of the techniques and systems that are described herein may include one or more of the following. The correct three-dimensional (3-D) incidence angle φ as well as the correct azimuth value θ of a seismic reflection event may be determined at a single seismic station, or unit, provided that the source wavelet and horizontal particle velocity components are available. In the case of overlapping or crossing events, the techniques that are described herein may still be used to decompose the events using one or more sensors.

It is noted that the techniques and systems that are described herein may be used for velocity picking by interpreting the estimated attributes, i.e., arrival time, amplitude as well as coherent incidence angles and azimuths together. Furthermore, the upgoing and downgoing parts of the recorded wavefield at the seismic units may be determined separately as well as in between the seismic units, which amounts to a joint upgoing and downgoing wavefield decomposition and reconstruction.

Due to attenuation, the wavefield changes as it passes through the subsurface. In other words, the wavefield loses energy through absorption, reflection and refraction at interfaces, mode conversion and geometrical spreading. The attenuation is frequency dependent. Attenuating basis functions may be used for the iterative inversion, in accordance with other embodiments of the invention which adds another dimension to the inversion process.

It is noted that the techniques that are described herein may be used for purposes of constructing the total synthetic wavelet based on the determined seismic event attributes at the seismic sensor locations, as well as at non-sensor locations. Furthermore, the techniques that are described herein may be used for purposes of constructing an upgoing synthetic wavefield and a downgoing synthetic wavefield at sensor and non-sensor locations.

The determined seismic event attributes, i.e. event time, scaling factor, incidence angle and azimuth may be stored or directly used as input for further processing.

Furthermore, the techniques that are described herein may be used for purposes of constructing an upgoing wavefield and/or a downgoing wavefield at sensor and non-sensor locations either individually or simultaneously.

For instance, in some embodiments in the invention, the upgoing wavefield at the seismic sensor locations, as well as at non-sensor locations, may be modeled directly based at least in part on the determined seismic event attributes.

In other embodiments of the invention, the upgoing wavefield at the seismic sensor locations, as well as at non-sensor locations, may be computed determining a synthetic downgoing wavefield based at least in part on the determined seismic event attributes and subtracting the determined synthetic downgoing wavefield from the corresponding observed wavefield (or interpolated observed wavefield).

It is noted that the downgoing wavefield at the seismic sensor locations, as well as at non-sensor locations, may also be modeled directly based at least in part on the determined seismic event attributes, or may be computed determining a synthetic upgoing wavefield based at least in part on the determined seismic event attributes and subtracting the determined synthetic upgoing wavefield from the corresponding observed wavefield (or interpolated observed wavefield).

It is also noted that in one embodiment the determined total synthetic wavefield, upgoing wavefield and/or downgoing synthetic wavefield at the seismic sensor locations, as well as at non-sensor locations may be stored, while in another embodiment they might be directly used as input for further processing, e.g., seismic imaging or velocity model building, etc.

Referring to FIG. 8, in accordance with some embodiments of the invention, a data processing system 320 may perform at least part of the techniques that are disclosed herein for purposes of determining attributes of seismic events. Thus, the system 320 may, in accordance with embodiments of the invention, receive seismic data indicative of pressure and/or particle motion measurements and process the seismic data to determine attributes of one or more measured seismic events. This determination is based at least in part on the seismic data and modeled wavefields having different sets of attributes (different angles of incidence and azimuths, as examples).

In accordance with some embodiments of the invention, the system 320 may include a processor 350, such as one or more microprocessors and/or microcontrollers. The processor 350 may be located on a streamer 30 (FIG. 1), located on the vessel 20 or located at a land-based processing facility (as examples), depending on the particular embodiment of the invention.

The processor 350 may be coupled to a communication interface 360 for purposes of receiving seismic data that corresponds to acquired pressure and/or particle motion measurements, source wavelet parameters, etc. Thus, in accordance with embodiments of the invention described herein, the processor 350, when executing instructions stored in a memory of the seismic data processing system 320, may receive multi-component data that is acquired by multi-component seismic sensors while in tow (seismic sensors located on streamers, for example). It is noted that, depending on the particular embodiment of the invention, the multi-component data may be data that is directly received from the multi-component seismic sensor as the data is being acquired (for the case in which the processor 350 is part of the survey system, such as part of the vessel or streamer) or may be multi-component data that was previously acquired by the seismic sensors while in tow and stored and communicated to the processor 350, which may be in a land-based facility, for example.

As examples, the interface 360 may be a USB serial bus interface, a network interface, a removable media (such as a flash card, CD-ROM, etc.) interface or a magnetic storage interface (IDE or SCSI interfaces, as examples). Thus, the interface 360 may take on numerous forms, depending on the particular embodiment of the invention.

In accordance with some embodiments of the invention, the interface 360 may be coupled to a memory 340 of the data processing system 320 and may store, for example, various input and/or output data sets involved with the techniques 200 and/or 250, as indicated at reference numeral 348. The memory 340 may store program instructions 344, which when executed by the processor 350, may cause the processor 350 to perform one or more of the techniques that are disclosed herein, such as the techniques 200 and/or 250 and display results obtained via the technique(s) on a display 351, which is coupled to the system 320 by a display interface 353, in accordance with some embodiments of the invention. The memory 340 may also store a library 347 of wavelet functions that describe seismic wavefields for different sets of propagation attributes (different incidence angles and azimuths, for example).

Other systems and techniques are contemplated and are within the scope of the appended claims. For example, in accordance with other embodiments of the invention, the techniques and systems that are disclosed herein may be applied to land-based or seabed-based seismic acquisition systems. For example, in accordance with some embodiments of the invention, the techniques and systems that are disclosed herein may be applied to buried receivers as well as vertical seismic profile (VSP) recordings, provided that the seismic velocities of the observed wave modes for the vicinity of the stations are known.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method comprising:
receiving seismic data acquired by at least one seismic sensor, the seismic data being indicative of at least one observed wavefield quantity associated with at least one seismic event;
determining a candidate event for said at least one observed wavefield quantity based at least in part on a ghost model, a source wavelet and a candidate value for at least one directional attribute quantity of said at least one seismic event;
correlating the candidate event with said at least one observed wavefield quantity; and
determining an event time based on the correlating.

2. The method of claim 1, wherein the act of determining the candidate event is further based on one or more of the following:
a sensor depth, a mass density, a wave propagation velocity in the medium surrounding said at least one seismic sensor, a free surface reflection coefficient and a type of wavefield quantity.

3. The method of claim 1, wherein the candidate event comprises a synthetic event or a modeled event.

4. The method of claim 1, further comprising:
based at least in part on the determined event time, the correlating and an energy of the candidate event, determining an event amplitude.

5. The method of claim 4, further comprising:
determining a residual based at least in part on the determined event amplitude, said at least one observed wavefield quantity and the candidate event.

6. The method of claim 5, further comprising:
accepting or rejecting said candidate value for at least one directional attribute quantity of said at least one seismic event based on the residual.

7. The method of claim 6, wherein the candidate value for at least one directional attribute quantity was rejected, the method further comprising:
changing said value of the at least one directional attribute quantity;
determining a new residual, comprising repeating determining the candidate event, determining the event time, determining the event amplitude and repeating determining the new residual; and
accepting the candidate value for at least one directional attribute quantity that corresponds to a substantially minimized residual.

8. The method of claim 6, further comprising:
determining a synthetic event based on the accepted candidate value for at least one directional attribute quantity, the corresponding event time and the corresponding event amplitude and removing the synthetic event from said at least one observed wavefield quantity; and
after the removal of the said synthetic event, repeating in an iterative sequence the determining of an acceptable value for at least one directional attribute quantity, a corresponding event time and a corresponding event amplitude of at least one other seismic event, and the removing of the corresponding determined synthetic event from said at least one observed wavefield quantity until the remaining energy is smaller than a defined threshold or the change in the remaining energy between iterations is smaller than a defined threshold.

9. The method of claim 6, further comprising:
determining a total synthetic wavefield at the location of each sensor of said at least one seismic sensor or the locations between pairs of seismic sensors of said at least one seismic sensor based at least in part on a value for at least one directional attribute quantity of said at least one seismic event, the determined event time and the determined event amplitude.

10. The method of claim 6, further comprising:
determining an upgoing wavefield at the location of each sensor of said at least one seismic sensor or the locations between pairs of seismic sensors of said at least one seismic sensor based at least in part on a value for at least one directional attribute quantity of said at least one seismic event, the determined event time and the determined event amplitude.

11. The method of claim 6, further comprising:
determining a downgoing wavefield at the location of each sensor of said at least one seismic sensor or the locations between pairs of seismic sensors of said at least one seismic sensor based at least in part on a value for at least one directional attribute quantity of said at least one seismic event, the determined event time and the determined event amplitude.

12. A system comprising:
an interface to receive seismic data acquired by at least one seismic sensor, the seismic data being indicative of at least one observed wavefield quantity associated with at least one seismic event; and
a processor adapted to process the seismic data to:
create a candidate event for said at least one observed wavefield quantity based at least in part on a ghost model, a source wavelet and a candidate value for at least one directional attribute quantity of said at least one seismic event;
correlate the candidate event with said at least one observed wavefield quantity; and
determine a candidate event time based on the correlation.

13. The system of claim 12, wherein the processor is adapted to process the seismic data further base determination of the candidate event on one or more of the following:
a sensor depth, a mass density, a wave propagation velocity in the medium surrounding said at least one seismic sensor, a free surface reflection coefficient and a type of wavefield quantity.

14. The system of claim 12, wherein the candidate event comprises a synthetic event or a modeled event.

15. The system of claim 12, wherein the processor is adapted to process the seismic data to based at least in part on the determined event time, the correlation and an energy of the candidate event, determining an event amplitude.

16. The system of claim 15, wherein the processor is further adapted to process the seismic data to determine a residual based at least in part on the determined event amplitude, said at least one observed wavefield quantity and the candidate event.

17. The system of claim 16, wherein the processor is further adapted to process the seismic data to:
accept or reject said candidate value for at least one directional attribute quantity of said at least one seismic event based on the residual.

18. The system of claim 17, wherein the candidate value for at least one directional attribute quantity was rejected, and the processor is further adapted to process the seismic data to:
change said value of the at least one directional attribute quantity;
determine a new residual, comprising repeating determining the candidate event, determining the event time, determining the event amplitude and repeating the determining of the new residual; and
accept the candidate value for at least one directional attribute quantity that corresponds to the a substantially minimized residual.

19. The system of claim 17, wherein the processor is further adapted to process the seismic data to:
determine a synthetic event based on the accepted candidate value for at least one directional attribute quantity, the corresponding event time and the corresponding event amplitude;
remove the synthetic event from said at least one observed wavefield quantity; and
after the removal of the said synthetic event, repeat in an iterative sequence the acts of determining of an acceptable value for at least one directional attribute quantity, a corresponding event time and a corresponding event amplitude of at least one other seismic event and removing the corresponding determined synthetic event from said at least one observed wavefield quantity until the remaining energy is smaller than a defined threshold or the change in the remaining energy between iterations is smaller than a defined threshold.

20. The system of claim 17, wherein the processor is further adapted to process the seismic data to:
determine a total synthetic wavefield at the location of each sensor of said at least one seismic sensor or the locations between pairs of seismic sensors of said at least one seismic sensor based at least in part on a value for at least one directional attribute quantity of said at least one seismic event, the determined event time and the determined event amplitude.

21. The system of claim 17, wherein the processor is further adapted to process the seismic data to:
determine an upgoing wavefield at the location of each sensor of said at least one seismic sensor or the locations between pairs of seismic sensors of said at least one seismic sensor based at least in part on a value for at least one directional attribute quantity of said at least one seismic event, the determined event time and the determined event amplitude.

22. The system of claim 17, wherein the processor is further adapted to process the seismic data to:
determine a downgoing wavefield at the location of each sensor of said at least one seismic sensor or the locations between pairs of seismic sensors of said at least one seismic sensor based at least in part on a value for at least one directional attribute quantity of said at least one seismic event, the determined event time and the determined event amplitude.
